(19) United States
(12) Patent Application Publication
(10) Pub. No.: US 2017/0059067 A1
(43) Pub. Date: Mar. 2, 2017

(54) CLAMP CONNECTOR

(71) Applicant: Aker Subsea AS, Lysaker (NO)

(72) Inventors: Bengt-Ove BERGQUIST, Sjuntorp (SE); Kristoffer SVENSSON, Oslo (NO); Roger ZANDER, Oslo (NO); Martin JUST, Oslo (NO); Joachim GJERDE, Oslo (NO)

(73) Assignee: Aker Subsea AS, Lysaker (NO)

(21) Appl. No.: 15/248,635

(22) Filed: Aug. 26, 2016

(30) Foreign Application Priority Data
Aug. 26, 2015 (NO) NO20151088

(51) Int. Cl. F16L 23/08; E21B 17/08

(52) U.S. Cl. CPC F16L 23/08; E21B 17/085

(57) ABSTRACT

A clamp connector (1) is designed for subsea operations. It is disposed around two different hubs for engaging and disengaging the hubs. It comprises clamp segments (9), bracket members (6) and ring elements (2). Each clamp segment (9) is so supported and configured in the connector (1), such that it can rotate tangentially and transversally along the respective ring element (2) for engaging and disengaging the hubs.

The present invention in general, relates to a clamp connector designed for subsea operation, which has a simple construction.

More specifically, the present invention relates to a clamp connector for subsea operation which connects two hubs in the subsea, such as say for example a manifold interface and a pipeline interface, and ensures minimum friction between moving parts during engagement and disengagement of the hubs, thereby doing away with the involvement of heavy and large constructional units.

More particularly, the present invention relates to a clamp connector designed for subsea operation, according to the preamble of claim 1.

### TECHNICAL BACKGROUND OF THE INVENTION

In on shore and off shore operations such as for hydrocarbon exploration and production, application of subsea clamp connectors are very common. These connectors are applied for attachment of various subsea assemblies for example say, two hubs such as a manifold interface and a pipeline interface. These two hubs may be two portions of a riser pipe assembly as well and the like as known to persons skilled in the art.

It is also common knowledge that during subsea operation, two hubs may have to be engaged and disengaged and for this purpose, the clamp connector is evenly disposed on the two hubs to be engaged and disengaged. Furthermore, during say engagement, the clamp segments have to move reasonably for tightening of the clamp, i.e, when the clamp closes for tightening the two hubs.

Now, it is known that during operation of the clamp connector apart from the connection forces, frictional forces are substantially high due to the enormous friction between the moving parts of the clamp connector. Hence, the construction elements usually have to be too heavy and large with complicated connections for overcoming these forces, so to ensure perfect tightening (or correct opening) of the two hubs during subsea operation, which itself involves other resistent forces as well. High frictional force involvement of the moving parts of the clamp connector also hampers the functioning of the clamp connector parts.

Hence, there has always been a concern for reducing the friction between moving parts of a clamp connector, during its functioning so that the components of the clamp connector, such for example the ring elements and the jack screw, are not too heavy and not too large, so as to render the clamp connector having a simple construction.

Granted U.S. Pat. No. 6,499,773 teaches clamp connector for connecting pipes preferably under water. It discloses radial movement of locking segments 14 after the connector is closed around the connecting flanges. This radial movement is achieved by tangential movement of split activating rings 26, which causes spring elements 13 pushing the inner activating rings 26 radially towards the connecting flanges. During use, there is a tightening bolt 10, which causes tangential movement of the inner activating rings 26 for transforming this movement into radial movement of the clamping segments. This helps in reducing clamp connectors' outer dimensions. However, this patent does not teach a simple arrangement whereby involvement of heavy and large constructional elements can be substantially reduced. In this case, the tangential movement of split activating rings 26 have to be caused for radial movement of the locking segments and thus frictional forces between moving parts is quite substantial.

The above disadvantage is applicable in respect of the teaching in US published patent application numbered 2011/0109081A as well. It essentially discloses clamping segments (280, 282, 284, 286) having outer cylindrical surfaces (400), which are engaged with similar surfaces (402) of tension bands (300, 302, 304, 306). The tension bands slide around the clamping segments. This arrangement apart from being a bit complicated also involves adjusting the ratio of the contact area of the tension bands to the clamping hubs to compensate for the difference in loading, due to the sliding friction between the tension band and the clamping hubs. This again leaves ample chances of inaccuracy in operation due to possible inaccuracy in adjustment.

Granted U.S. Pat. Nos. 478,406 and 6,290,182 do disclose chains and rollers respectively below moving parts for reducing friction, however, in both these patents the clamp segments have to move in relation to the flanges rendering the connection forces high in the last phase of connection and thus ring elements and jack screw and other component parts of the clamp connector, may have to dimensioned quite heavily, for overcoming the frictional forces and the connection forces together.

EP1767842, teaches hermetically sealing end portions of two pipes by means of a housing type joint. The joint is formed by three circumferentially disposed arcuate joints having gaps in between each other. The joint has an elastic ring, which has projections that can engage with holes in the three arcuate segments. Fastening bands are provided one around each arcuate segment, for enabling them closer to each other. This document has no teaching regarding how to keep the size and weight of a subsea clamp connector parts to a minimum, by substantially reducing the friction between moving parts during use of the clamp connector.

The present invention meets the need as stated before by providing a clamp connector for subsea operation which has a simple construction and the friction between moving parts is substantially low during operation.

### OBJECTS OF THE INVENTION

It is the principal object of the present invention to provide a clamp connector for engaging and disengaging two hubs during subsea operation, which has a simple construction and is capable of bringing down the frictional forces between moving parts of the connector, to a substantially low degree, during the use of the connector.

It is another object of the present invention to provide a clamp connector for subsea operation, which can engage and disengage two hubs, such for example a manifold interface and a pipe interface, in a very simple manner using a simple construction and involves (i) substantially low friction between moving parts and (ii) substantially low connection forces.

It is a further object of the present invention to provide a clamp connector for subsea operation which can be easily deployed and operated by applying a ROV, due to its simple construction which avoids use of very large and heavy component parts.

How the foregoing objects are achieved and some other advantageous features, still not disclosed in prior art, will be clear from the following non-limiting description.

All through the specification including the claims, the words, “connector”, “clamp connector”, “clamping segment”, “pin”, “bracket”, “ring element”, “manifold interface”, “piping interface”, “jack screw”, “connection forces”, “segment limiter”, are to be interpreted in the broadest sense of the respective terms and includes all similar items in the field known by other terms, as may be clear to persons skilled in the art. Restriction/limitation, if any, referred to in the specification, is solely by way of example and understanding the present invention.

### SUMMARY OF THE INVENTION

Accordingly, the present invention provides a clamp connector designed for subsea operations and disposed around two different hubs for engaging and disengaging the hubs. It comprises clamp segments, bracket members and ring elements. Each clamp segment is so supported and configured in the connector, such that it can rotate tangentially and transversally along the respective ring element for engaging and disengaging the hubs.

Preferably, there is a connection pin in engagement with a flexible element at the top portion of each clamp segment, which can restrict the movement of the clamp segment tangentially and transversely to the desired extent needed, for closing of the clamp connector.

More preferably, the pin segment is received inside a bracket along a slot and is secured to it by means of a circlip along the top portion of the slot and in that the bracket is attached to the ring elements along a slotted interface.

Even more preferably, the bracket is received on a segment limiter which is a flexible element and the segment limiter, with the bracket atop it, is fitted onto the base of the clamp connector along a slot and there is always some clearance between the bracket and the segment limiter.

Most preferably, the segment limiter also has a slot aligned with the bracket slot to ensure that the pin passes through both the bracket slot and the segment limiter slot.

The segment limiter interfaces against the clamp segment in a slot and against the pin with pin-in-hole contact.

### BRIEF DESCRIPTION OF THE ACCOMPANYING FIGURES

Having described the main features of the invention above, a more detailed and non-limiting description of a preferred embodiment is given in the following with reference to the drawings, in which:

FIG. 1a is an exploded view of a preferred embodiment of the clamp connector according to the present invention.

FIG. 1b is a view of the clamp connector in FIG. 2a with all components in position.

FIG. 2a is a perspective view of the clamp connector in FIG. 2a showing the connectivities between the components with greater details.

FIG. 2b is an enlarged front view of the clamp connector showing the direction of segment travel during use.

### DETAILED DESCRIPTION OF THE INVENTION

The following provides a detailed non-limiting description of a preferred embodiment of the present invention which is purely exemplary.

In the accompanying figures which describe two preferred embodiments, like reference numerals represent like features. Further, if and when it is referred to as “top”, “bottom”, “upward”, “downward”, “above” or “below” and similar terms, this is strictly referring to an orientation with reference to the sea bed, where the sea bed is substantially horizontal and is at the bottom.

It should also be understood that the orientation and numbers of the various components may be otherwise than shown in the drawings, without deviating from the principle of the invention.

As stated before the clamp connector 1 according to the present invention connects two hubs in subsea conditions, such as say for example it connects a manifold interface with a pipeline interface. It is also common knowledge that two hubs are brought close to each other and are joined once the connector is closed. It is also known that a subsea clamp connector on joining two such hubs, usually with a metallic seal creates a tight connection, by added torque. These aspects are not elaborated further or illustrated herein in this specification, as these aspects are known and not consequential to the present invention.

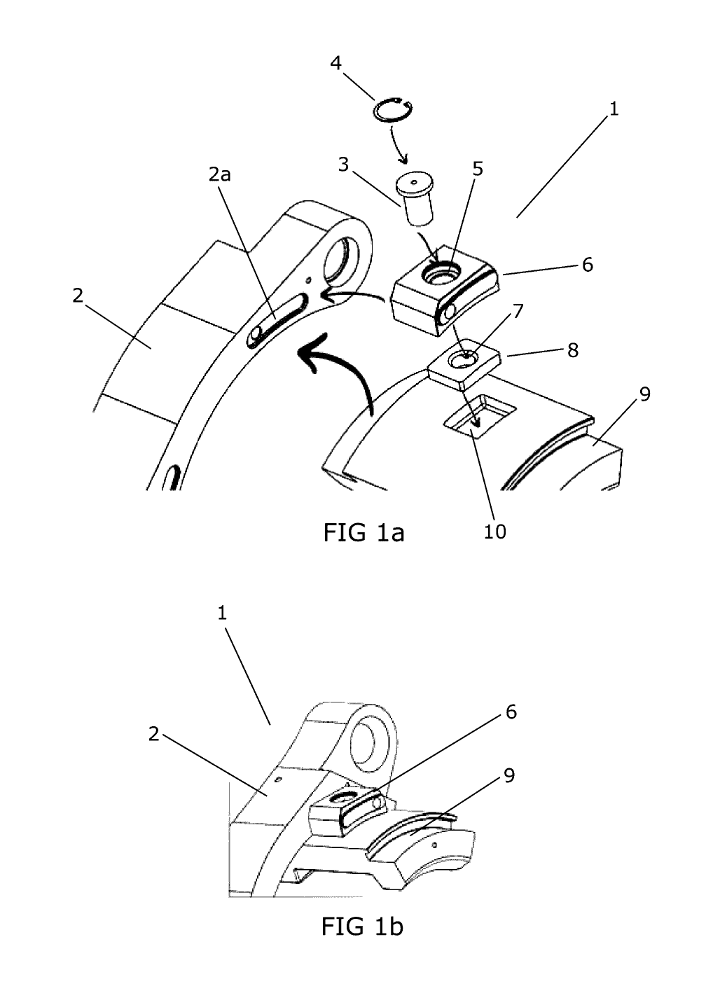

It has been deciphered according to the present invention that to lower the torque needed to close the clamp to match the capacity of the standard torque tools, the clamp segments 9 (best shown in FIG. 1a) should have the freedom to move in transversal direction as the clamp connectors are being closed and this movement, should take place along the ring elements 2 (best shown in FIG. 1a). This is also true for opening of the connector 1. These aspects would be clear from the further description hereinafter, particularly from the structure and the functioning of the clamp connector according to the present invention.

FIG. 1a is an exploded view of the basic structure of the clamp connector 1.

The clamp connector 1 is designed for subsea operations and disposed around two different hubs (not shown) for engaging and disengaging the hubs. It comprises clamp segments 9, bracket members 6 and ring elements 2.

Referring to FIG. 1a, each clamp segment 9 is provided with grooves (not shown in detail) which fits in to corresponding grooves (not shown in detail) of a ring element 2. This is a detachable fitting and not a rigid fitting.

From FIG. 1a it would be clear that at the top portion of each clamp segment 9, there is a connection pin 3. The top portion of the pin 3 or the pin segment limiter 3 is secured inside a bracket/bracket segment limiter 6 by means of a circlip 4. The bracket 6 is attached to the ring elements 2 by means of a slotted interface 2a. The functions of these features have been explained little later.

The bracket 6 is received on a segment limiter 8, which is made of resilient material. In this preferred embodiment it is rubber. However, it can be made of any other resilient material and this is within the scope of the present invention.

The rubber segment limiter 8, with the bracket 6 atop it, is fitted onto the base of the clamp segment 9 along a slot 10. The bracket has a slot 5 which receives the pin 3 and along this slot 5, the pin 3 is attached to the bracket 6 by means of the circlip 4. The rubber segment limiter 8 also has a slot 7 aligned with the bracket slot 5. This ensures that the pin 3 passes through rubber segment limiter slot 7 while the bracket 6 rests above the rubber segment limiter 8. There is however, always some clearance between the segment limiter 8 and the bracket 6.

FIG. 1b is a view of the clamp connector 1 with the components in place.

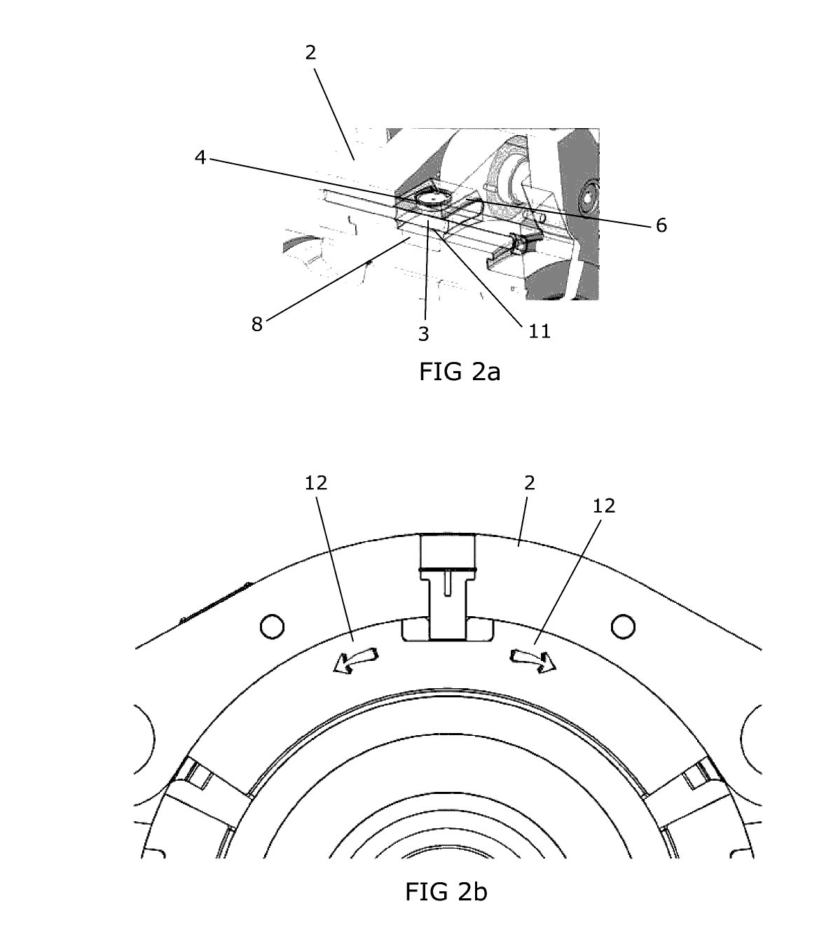

From the elaborate internal view of the connector 1 in FIG. 2a it would be clear that the rubber segment limiter 8 interfaces against the clamp segment 9 in a slot (not shown) and against the pin 3 with pin-in-hole contact 11.

FIG. 2b is an enlarged sectional view of the clamp connector 1 showing the clamp segment movement 12 relative to the ring elements 2. This figure has been again taken up later, while explaining the functioning of the clamp connector 1.

How the various features function and interact with each other is now discussed with reference to some of the figures which are now described without elaborating the stuctural part, as that has been adequately covered hereinbefore.

Referring to FIGS. 1a and 2a in particular, the bracket 6 inside which the pin 3 is located, is attached to the ring elements 2 along an interface 2a, while the rubber bushing 8, on which the pin 3 rests along a contact 11, interfaces with the segments 9. As stated before, each clamp segment 9 is provided with grooves (not shown in detail) which fits in to corresponding grooves (not shown in detail) of a ring element 2. This is a detachable fitting and not a rigid fitting.

The simple arrangement, as detailed in the preceding paragraphs, ensure that when the clamp closes, the rubber bushing/rubber segment limiter 8 keeps the segments 9 in place until connection forces lead to sufficient friction forces between the connecting flanges (not shown in detail) and the segments 9. The pin 3 standing on the rubber bushing 8 limits the movement of the segments 9 tangentially and transversely and keeps the segments 9 in place. It controls the movement of the segments 9 to the desired extent during closing of the clamp connector.

The above arrangement also ensures that during closing of the clamp connector 1, the clamp segments 9 move transversely and tangentially along the ring elements 2 as specifically shown in FIG. 2b, where the movement direction 12 is indicated by arrows.

Preferably, the movement of the clamp segments 9 is restricted to ±10 mm. Hence, the frictional forces due to movement of the moving parts 9 are substantially low, whereby the necessity for heavy, large and complicated components and corresponding connectivities are dispensed with. Thus, the connection forces are also low. Precisely, during closing of the connector 1, the connection forces and the frictional forces, which have to be overcome, are substantially low rendering the clamp connector construction and its operation simple and easy to operate, apart from being economic as well. These aspects are also true for opening of the connector 1 as well as will be understood by persons skilled in the art.

The preferred embodiment described above refers to the segment limiter 8 as a rubber segment limiter. However, as clearly explained hereinbefore, this segment limiter 8 can be made of any suitable resilient material, so that it is reasonably flexible.

According to the invention, the segment limiter is made up of a material that deforms in a suitable manner at a given load, the hardness depending on the weight of the segments and the desired movement of such segments for closing the clamp. The segment limiter may be made up of an elastomer, which is chosen according to robustness to temperatures and inert qualities needed.

The work needed to deform the segment limiter material must be lower than the sliding friction work between the hub and segment. For a horizontal connection system, the largest segment should be in a vertical position and hanging on the rubber by most of its self-weight. The material should not deform more than a couple of millimetres to have room for additional movement when closing the clamp connector.

Unlike conventional clamp connectors, the clamp segments 9 are not rigidly fixed to the ring elements 2. Hence, the segments 9 do not have a tangential movement in relation to the flanges in the last phase of the connection process and thus do not slide along the flanges when the connection forces are at their maximum. Thus, the frictional forces are low and the parts such as the ring elements and the jackscrew need not be too large and heavy.

From the description, it would be clear that the construction and mode of operation of the tool is not only simple but also technically sound.

From the foregoing description and also from the appended claims it would be clear to persons skilled in the art, that all the objectives of the present invention are achieved.

The present invention has been described with reference to a preferred embodiment and drawings for the sake of understanding only and it should be clear to persons skilled in the art, that the present invention includes all legitimate modifications within the ambit of what has been described hereinbefore and claimed in the appended claims.

1. A clamp connector designed for subsea operations and disposed around two different hubs for engaging and disengaging the hubs, the clamp connector comprising:
clamp segments;
bracket members;
ring elements; and
wherein each clamp segment is so supported and configured in the connector, such that it can rotate tangentially and transversely along the respective ring element for engaging and disengaging the hubs.

2. The clamp connector according to claim 1, wherein there is a connection pin in engagement with a flexible element at the top portion of each clamp segment, which can restrict the movement of the clamp segment tangentially and transversely to the desired extent needed, for closing of the clamp connector.

3. The clamp connector according to claim 2, wherein the pin segment is received inside a bracket along a slot and is secured to it via a circlip along the top portion of the slot and in that the bracket is attached to the ring elements along a slotted interface.

4. The clamp connector according to claim 3, wherein the bracket is received on a segment limiter which is a flexible element and the segment limiter, with the bracket atop it, is fitted onto the base of the clamp connector along a slot and there is always some clearance between the bracket and the segment limiter.

5. The clamp connector according to claim 3, wherein the segment limiter also has a slot aligned with the bracket slot to ensure that the pin passes through both the bracket slot and the segment limiter slot.

6. The clamp connector according to claim 5, wherein the segment limiter interfaces against the clamp segment in a slot and against the pin with pin-in-hole contact.

7. The clamp connector according to claim 4, wherein the segment limiter is made up of a resilient material that deforms in a suitable manner at a given load, the hardness depending on the weight of the segments and the desired movement of such segments for closing the clamp.

8. The clamp connector according to claim 4, wherein the segment limiter is made up of an elastomer which is chosen according to robustness to temperatures and inert qualities needed.

9. The clamp connector according to claim 1, wherein each clamp segment is provided with grooves which fits in to corresponding grooves of a ring element.
